(19) United States
(12) Patent Application Publication
(10) Pub. No.: US 2003/0021615 A1
(43) Pub. Date: Jan. 30, 2003

(54) Image forming apparatus

(75) Inventors: Kazuo Asano, Ebina-shi (JP); Isao Ito, Iwatsuki-shi (JP); Toshio Masubuchi, Iwatsuki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/167,424

(22) Filed: Jun. 13, 2002

(30) Foreign Application Priority Data
Jun. 15, 2001 (JP) 2001-182393

(51) Int. Cl. G03G 15/01

(52) U.S. Cl. 399/299; 399/302

(57) ABSTRACT

An image forming apparatus including a plurality of image carriers for carrying toner images of different colors respectively, a plurality of primary transferrers which abut against a part of the plurality of image carriers respectively so that the toner images on the image carriers are primarily transferred to the plurality of primary transferrers, a secondary transferrer which abuts against all of the plurality of primary transferrers so that toner images on the primary transferrers are secondarily transferred to the secondary transferrer, and a tertiary transferrer which abuts against the secondary transferrer so that a toner image on the secondary transferrer is tertiarily transferred to a recording medium. In the image forming apparatus, a black toner image is not transferred to at least a primary transferrer located most upstream in the rotating direction of the secondary transferrer with reference to the position where the tertiary transferrer abuts against the secondary transferrer.

### BACKGROUND OF THE INVENTION

1. Field of the Invention

The present invention relates to an image forming apparatus using an electrophotographic system, such as a copying machine, a printer, a facsimile machine or a complex machine of these, and particularly relates to improvements of an image forming apparatus in which toner images of a plurality of colors are superimposed on one another so as to obtain a color image.

2. Background Art

A color image forming apparatus such as a copying machine or a printer using an electrophotographic system (electrostatic transfer system) has been heretofore known widely. In such a color image forming apparatus, for example, three kinds of unicolor images of yellow, magenta and cyan or four kinds of unicolor images of these three colors and black are formed on photoconductors, and electrostatic transfer is repeated by contact type transfer units in a plurality of stages. Thus, a color toner image in which the unicolor toner images have been superimposed on one another is finally obtained on a recording medium such as paper.

On the other hand, in electrostatic transfer, there may occur problems as follows. First, residual toner or a transfer potential hysteretic image that has not been transferred in a transfer position in the lower stage reaches a transfer position in the upper stage again so as to cause an obstacle to transferring in the transfer position in the upper stage. Second, when the charging quantity of the toner is high or when transfer bias is high, there is a fear that toner flies in all directions to cause an image defect (toner spread or blur) immediately before transferring. Third, toner whose polarity has been reversed in respective transfer steps may be finally mixed into a developing unit so that an original toner color cannot be obtained.

### SUMMARY OF THE INVENTION

The invention was developed in consideration of such technical problems. An object of the invention is to provide an image forming apparatus in which image defects caused by electrostatic transfer are reduced.

An image forming apparatus according to a first aspect of the invention comprises: a plurality of image carriers for carrying toner images; a plurality of primary transferrers each abutting against at least one of the image carrier so that the toner images on the image carrier are primary transferred thereto; a secondary transferrer abutting against at least two of the primary transferrers so that the toner images on the primary transferrers are secondary transferred thereto; and a tertiary transferrer abutting against the secondary transferrer to tertiarily transfer a toner image on the secondary transferrer to a predetermined medium. In the image forming apparatus, a black toner image is transferred to one of the primary transferrer other than the primary transferrer located most upstream in a rotating direction of the secondary transferrer with reference to a first position where the tertiary transferrer abuts against the secondary transferrer.

An image forming apparatus according to another aspect of the invention comprises: a plurality of image carriers for carrying toner images of different colors respectively; a plurality of primary transferrers each abutting against at least one of the image carrier so that the toner images on the image carrier are primary transferred thereto; a secondary transferrer abutting against at least two of the primary transferrers so that the toner images on the primary transferrers are secondary transferred thereto; and a tertiary transferrer abutting against the secondary transferrer to tertiarily transfer a toner image on the secondary transferrer to a predetermined medium. In the image forming apparatus, a black toner image is transferred to one of the primary transferrer located most downstream in a rotating direction of the secondary transferrer with reference to a first position where the tertiary transferrer abuts against the secondary transferrer.

An image forming apparatus according to another aspect of the invention comprises: a plurality of image carriers for carrying toner images; a plurality of primary transferrers abutting against at least one of a plurality of the image carriers so that the toner images on the image carriers are primarily transferred thereto; a secondary transferrer abutting against at least two of the primary transferrers so that toner images on the primary transferrers are secondarily transferred thereto; and a tertiary transferrer abutting against the secondary transferrer to tertiarily transfer a toner image on the secondary transferrer to a predetermined medium. In the image forming apparatus, a plurality of the image carriers abut against one of the primary transferrers; and a toner image formed on the image carrier located upstream in a rotating direction of the primary transferrer is higher in brightness than a toner image formed on the image carrier located downstream with reference to a second position where the secondary transferrer abuts against the primary transferrer.

Here, “An image forming apparatus having a plurality of image carriers for carrying toner images, a plurality of primary transferrers each abutting against at least one of the image carrier so that the toner images on the image carrier are primary transferred thereto, a secondary transferrer abutting against at least two of the primary transferrers so that the toner images on the primary transferrers are secondary transferred thereto, and a tertiary transferrer abutting against the secondary transferrer to tertiarily transfer a toner image on the secondary transferrer to a predetermined medium” may be configured as follows. That is, as shown in FIGS. 1A to 1C, (1) the same number of image carriers may abut against each of primary transferrers (see FIG. 1A), or different numbers of image carriers may abut against the primary transferrers respectively (see FIGS. 1B and 1C). In addition, (2) a plurality of image carriers may abut against one primary transferrer (see FIG. 1A), or a single image carrier may abut against one primary transferrer (see primary transferrer B in FIG. 1B or primary transferrer A or C in FIG. 1C). Further, (3) two primary transferrers may be provided (see FIGS. 1A and 1B), or three or more (three in FIG. 1C) primary transferrers maybe provided.

On the other hand, “a primary transferrer located most upstream in the rotating direction of the secondary transferrer with reference to the position where the tertiary transferrer abuts against the secondary transferrer” means the primary transferrer A in the configurations of FIGS. 1A to 1C. Further, “a primary transferrer located most downstream in the rotating direction of the secondary transferrer with reference to the position where the tertiary transferrer abuts against the secondary transferrer” means the primary transferrer B in the configuration of FIG. 1A or 1B, or the primary transferrer C in the configuration of FIG. 1C. Incidentally, the arrows in the drawings indicate the rotating directions of respective image carriers and respective transferrers.

Further, the invention embodying the configuration of FIG. 1A provides an image forming apparatus including four image carriers for carrying color toner images of yellow, magenta, cyan and black respectively; a first primary intermediate transferrer abutting against two of the image carriers so that toner images on the two image carriers are primarily transferred thereto; a second primary intermediate transferrer abutting against the other two of the four image carriers so that toner images on the other two image carriers are primarily transferred thereto; a secondary intermediate transferrer abutting against the first and second primary intermediate transferrers so that toner images on the first and second primary intermediate transferrers are secondarily transferred thereto; and a final transferrer abutting against the second intermediate transferrer to finally transfer a toner image on the secondary intermediate transferrer to a recording medium. In the image forming apparatus, the first primary intermediate transferrer is located upstream in a rotating direction of the secondary intermediate transferrer with reference to a first position where the final transferrer abuts against the secondary intermediate transferrer; the second primary intermediate transferrer is located downstream in a rotating direction of the secondary intermediate transferrer with reference to the first position; and a black toner image is transferred to the second primary intermediate transferrer.

An image forming apparatus according to another aspect of the invention comprises: four image carriers for carrying color toner images of yellow, magenta, cyan and black respectively; a first primary intermediate transferrer abutting against two of the image carriers so that toner images on the two image carriers are primarily transferred thereto; a second primary intermediate transferrer abutting against the other two of the four image carriers so that toner images on the other two image carriers are primarily transferred thereto; a secondary intermediate transferrer abutting against the first and second primary intermediate transferrers so that toner images on the first and second primary intermediate transferrers are secondarily transferred thereto; and a final transferrer abutting against the second intermediate transferrer to finally transfer a toner image on the secondary intermediate to a recording medium. In the image forming apparatus, with reference to a second position where the secondary intermediate transferrer abuts against the primary intermediate transferrer, a toner image formed on an image carrier located upstream in a rotating direction of the primary intermediate transferrer is higher in brightness than a toner image formed on an image carrier located downstream.

Further, a toner image of the image carrier located most downstream in the rotating direction with reference to the second position may be yellow.

An image forming apparatus according to another aspect of the invention comprises a plurality of image carriers for carrying toner images; a plurality of primary transferrers each abutting against at least one of the image carrier so that the toner images on the image carrier are primary transferred thereto; a secondary transferrer abutting against at least two of the primary transferrers so that the toner images on the primary transferrers are secondary transferred thereto; and a tertiary transferrer abutting against the secondary transferrer to tertiarily transfer a toner image on the secondary transferrer to a predetermined medium. In this forming apparatus, a black toner image is carried by one of the image carriers abutting against the primary transferrers excluding one located most upstream in a rotating direction of the secondary transferrer with reference to a first position where the tertiary transferrer abuts against the secondary transferrer.

### BRIEF DESCRIPTION OF THE DRAWINGS

FIGS. 1A is a view for explaining examples of configurations according to the invention.

FIGS. 1B is a view for explaining examples of configurations according to the invention.

FIGS. 1C is a view for explaining examples of configurations according to the invention.

FIG. 2 is a schematic sectional view of a full color printer according to an embodiment of the invention.

FIG. 3 is a schematic sectional view of a main portion of the full color printer shown in FIG. 2.

FIG. 4 is a view for explaining transfer steps of the full color printer shown in FIG. 2.

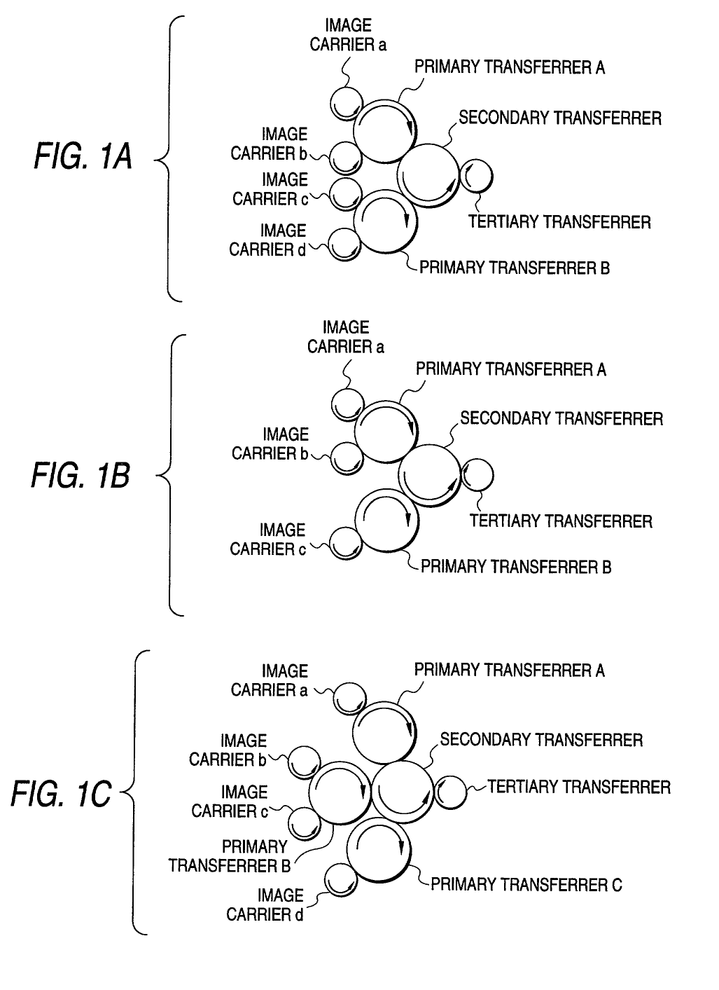

### DETAILED DESCRIPTION OF THE PREFERRED EMBODIMENTS

Description will be made below about an embodiment of the invention with reference to the drawings.

Embodiment

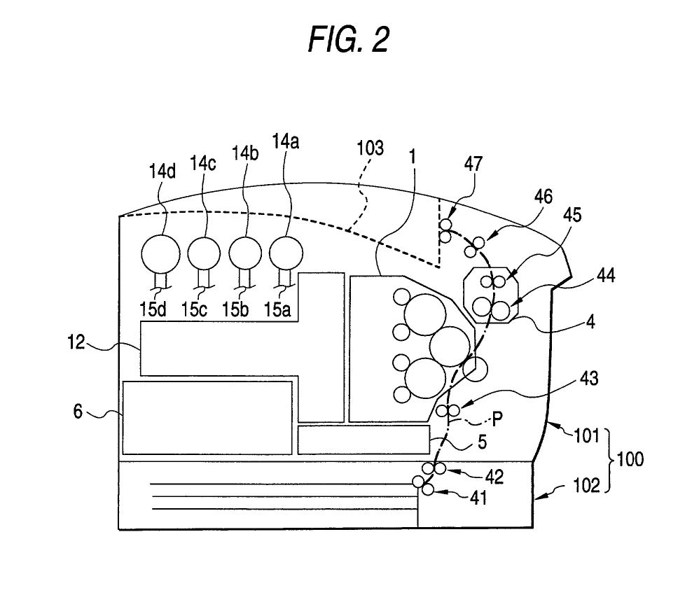

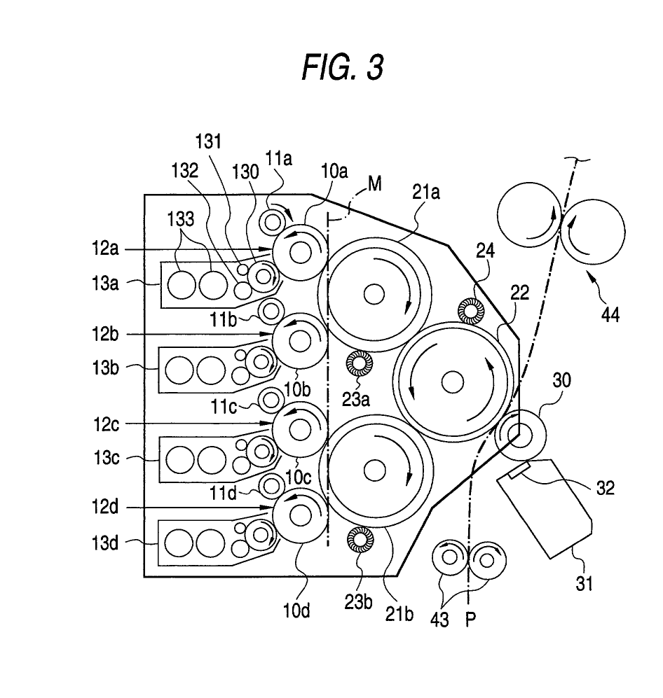

FIG. 2 shows a full color printer 100 as an image forming apparatus according to an embodiment of the invention. In addition, FIG. 3 shows the image forming main portion of the full color printer 100 shown in FIG. 2, more minutely. Incidentally, the arrows in FIG. 2 show the rotating directions of respective rotary members. The fundamental configuration of the image forming apparatus and the operation of an image forming mode thereof will be described below.

Generally, this full color printer 100 is constituted by a printer body 101 and a paper feed tray portion 102 as shown in FIG. 2. The printer body 101 has an image forming unit 1, an exposure unit 12, toner cartridges 14a to 14d each used for any one of yellow Y, magenta M, cyan C and black K, toner supply flexible pipes 15a to 15d extending from the toner cartridges 14a to 14d to not-shown developing units corresponding to the colors respectively, a control unit 6, a power supply unit 5 and a fixing unit 4.

In addition, a pair of feed rolls 41, a pair of first carrying rolls 42, a pair of resist rolls 43, a pair of second carrying rolls 45 (in the fixing unit 4 ), a pair of third carrying rolls 46 and a pair of discharge rolls 47 are provided between the paper feed tray 102 and a paper discharge tray 103 of the printer body 101.

Further, as shown in FIG. 3, the image forming unit 1 of the printer body 101 has a main portion constituted by photoconductor drums (image carriers) 10a to 10d each corresponding to any one of yellow Y, magenta M, cyan C and black K, charging rolls (contact type charging units) 11a to lid for primary charging in contact with these photoconductor drums 10a to 10d, developing units (two-component developing units) 13a to 13d corresponding to the respective colors, a first primary intermediate transfer drum (intermediate transferrer) 21a in contact with the two photoconductor drums 10a and 10b of the four photoconductor drums 10a to 10d, a second primary intermediate transfer drum (intermediate transferrer) 21b in contact with the other two photoconductor drums 10c and 10d, a secondary intermediate transfer drum (intermediate transferrer) 22 in contact with the first and second primary intermediate transfer drums 21a and 21b, and a final transfer roll (final transferrer) 30 in contact with this secondary intermediate transfer drum 22.

The photo conductor drums 10a to 10d are disposed at regular intervals so as to have a common tangent plane M. In addition, the first primary intermediate transfer drum 21a and the second primary intermediate transfer drum 21b are disposed so that their rotating axes are parallel to the axes of the photoconductor drums 10a to 10d and have a relationship of plane symmetry with respect to a predetermined symmetry plane. Further, the secondary intermediate transfer drum 22 is disposed so that its rotating axis is parallel to the rotating axes of the respective photoconductor drums 10a to 10d.

Signals corresponding to image information for every color are rasterized by a not-shown image processing unit and supplied to the exposure unit 12. In this exposure unit 12, laser beams 12a to 12d each corresponding to any one of the colors of yellow Y, magenta M, cyan C, and black K are modulated, and the photoconductor drums 10a to 10d are irradiated with the laser beams 12a to 12d of corresponding colors respectively.

Around the photoconductor drums 10a to 10d, an image forming process based on a known electrophotographic system is executed for every color. First, for example, a photoconductor drum using an OPC photoconductor with a diameter of 20 mm is used as each of the photoconductor drums 10a to 10d. These photoconductor drums 10a to 10d are driven to rotate, for example, at a rotational speed of 95 mm/sec. As shown in FIG. 3, a DC voltage of about −840 V is applied to the charging rolls 11a to lid as contact type charging units, so that the surfaces of the photoconductor drums 10a to 10d are charged to, for example, about −300 V. Incidentally, although examples of the contact type charging units may include roll type ones, film type ones, and brush type ones, any type of charging units may be used. In this embodiment, there are adopted charging rolls which have been generally used in an electrophotographic apparatus in recent years. In addition, although a charging system for applying only DC is adopted to charge the surfaces of the photoconductor drums 10a to 10d in this embodiment, a charging system for applying AC and DC may be used.

After that, the surfaces of the photoconductor drums 10a to 10d are irradiated with the laser beams 12a to 12d each corresponding to any one of the colors of yellow Y, magenta M, cyan C, and black K by a not-shown laser optical unit as the exposure unit. Thus, electrostatic latent images corresponding to input image information of the respective colors are formed. When the electrostatic latent images are written in the photoconductor drums 10a to 10d by the laser optical unit, the surface potentials of the image exposure portions of the photoconductor drums 10a to 10d are destaticized to, for example, about −60 V or lower.

In addition, the electrostatic latent images each corresponding to any one of the colors of yellow Y, magenta M, cyan C, and black K formed in the surfaces of the photoconductor drums 10a to 10d are developed by the developing units 13a to 13d in accordance with the respective colors. Thus, the electrostatic latent images are visualized as toner images of the respective colors on the photoconductor drums 10a to 10d.

The developing units 13a to 13d are filled with two-component developers each composed of toner of any one of different colors of yellow Y, magenta M, cyan C, and black K, and carriers, respectively. As the kind of toner to be used, pulverized toner and spherical toner are acceptable. In this embodiment, spherical toner is used. Incidentally, toner having a free form, such as pulverized toner, has a large contact surface relative to an attachment surface. Thus, the adhesive force of such toner is so large that the toner is difficult to transfer to the surface of a destination to be transferred. On the other hand, spherical toner has a small contact surface relative to an attachment surface. Thus, the adhesive force of the spherical toner is so small that the transfer efficiency is high. In addition, as the method for producing spherical toner, there has been known a method in which heat treatment is applied to toner produced in an emulsion polymerization method, a suspension polymerization method, a solution suspension method, or a kneading and pulverizing method. Incidentally, the spherical toner means toner whose shape factor M1 is in a range of M1<125, preferably in a range of M1<120, in the following expression.

M1=(π·dmax²/4A)×100

wherein dmax designates the maximum diameter of toner, and A designates the sectional area of toner

These developing units 13a to 13d are supplied with the toner of corresponding colors from the corresponding toner cartridges 14a to 14d through the corresponding toner supply flexible pipes 15a to 15d shown in FIG. 2, respectively. The supplied toner of each color is stirred with the carriers sufficiently by an auger. 133 so as to be tribo-charged to negative polarity. In each developing roll 130, a magnet roll (not shown) in which a plurality of magnetic poles are disposed at predetermined angles is fixedly disposed. The developer conveyed to the vicinity of the surface of the developing roll 130 by a paddle 132 for conveying the developer to the developing roll 130 is regulated in quantity to be conveyed to the developing portion by a developer quantity regulating member 131. In this embodiment, the quantity of the developer on the developing roll 130 is 30-50 g/m². In addition, the charging quantity of the toner existing on the developing roll 130 at this time is approximately 20-35 μC/g.

The toner supplied onto the developing roll 130 is formed into a magnetic brush shape constituted by the carriers and the toner by the magnetic force of the magnet roll. This magnetic brush abuts against the photoconductor drum 10a, 10b, 10c or 10d. An AC and DC development bias voltage is applied to the developing roll 130 so that the toner on the developing roll 130 is developed on the electrostatic latent image formed on the photoconductor drum 10a, 10b, 10c or 10d. Thus, a toner image is formed. In this embodiment, the AC component of the development bias voltage is set to have 4 kHz and 1.5 kVpp, and the DC component thereof is set at about −200 V.

Next, the toner images formed on the photoconductor drums 10a to 10d respectively and each corresponding to any one of yellow Y, magenta M, cyan C and black K are electrostatically and primarily transferred onto the first and second primary intermediate transfer drums 21a and 21b. That is, of the toner images of yellow Y, magenta M, cyan C and black K, two color toner images formed on the photoconductor drums 10a and 10b are primarily transferred onto the first primary intermediate transfer drum 21a. On the other hand, of the toner images of yellow Y, magenta M, cyan C and black K, the other two color toner images formed on the photoconductor drums 10c and 10d are primarily transferred onto the second primary intermediate transfer drum 21b.

Thus, a unicolor image transferred from the photoconductor drum 10a or 10b, or a two-color image in which toner images of two colors transferred from both the photoconductor drums 10a and 10b have been put on top of each other, is formed on the first primary intermediate transfer drum 21a. On the other hand, a unicolor image or a two-color image from one or each of the photoconductor drums 10c and 10d is formed likewise on the second primary intermediate transfer drum 21b.

The surface potential required for electrostatically transferring toner images from the photoconductor drums 10a to 10d onto the first and second primary intermediate transfer drums 21a and 21b is approximately in a range of from +250 V to +500 V. This surface potential is set at an optimum value in accordance with the charging state of toner, the atmospheric temperature, or the humidity. The atmospheric temperature or the humidity can be known easily by detecting the resistance value of a member having a characteristic that the resistance value varies in accordance with the atmospheric temperature or the humidity. As described above, when the charging quantity of the toner is in a range of 20-35 μC/g, and under the environment of ordinary temperature and ordinary humidity, it is desired that the surface potential of each of the first and second primary intermediate transfer drums 21a and 21b is about +400 V.

For example, each of the first and second primary intermediate transfer drums 21a and 21b used in this embodiment is formed to have an outer diameter of 42 mm, and the electric resistance value R is set at about 10⁸ Ω. Each of the first and second primary intermediate transfer drums 21a and 21b is a cylindrical body of revolution, which is constituted by a single layer or a plurality of layers and the surface of which has flexibility or elasticity. Generally, a low-resistance elastic rubber layer (R=10²−10³ Ω) represented by conductive silicon rubber or the like is provided in a thickness of about 0.1-10 mm on a metal pipe serving as a metal core made of Fe, Al or the like. Further, in the outermost surface of each of the first and second primary intermediate transfer drums 21a and 21b, typically, fluoro-rubber in which fluoro-resin particulates have been dispersed is formed as a high-releasable layer (R=10⁵−10⁹ Ω) 3-100 μm thick, and bonded by a silane coupling agent-based bonding agent (primer).

Here, the important factors are the resistance value and the surface releasability. There is no particular limit in material so long as the material of the high-releasable layers has a resistance value of about R=10⁵−10⁹ Ω, and high releasability. Incidentally, first and second primary cleaning rolls 23a and 23b are attached to the first and second primary intermediate transfer drums 21a and 21b so as to rotate to follow the first and second primary intermediate transfer drums 21a and 21b, respectively. Each of these primary cleaning rolls 23a and 23b is formed by coating a metal roll body with a piece of flocked tape of a conductive brush, and a predetermined cleaning bias is applied thereto.

In such a manner, the unicolor or two-color toner images formed on the first and second primary intermediate transfer drums 21a and 21b are electrostatically and secondarily transferred onto the secondary intermediate transfer drum 22. Thus, a final toner image ranging from a unicolor image to a four-color image of yellow Y, magenta M, cyan C and black K is formed on the secondary intermediate transfer drum 22.

The surface potential required for electrostatically transferring toner images from the first and second primary intermediate transfer drums 21a and 21b onto the secondary intermediate transfer drum 22 is approximately in a range of from +600 V to +1,200 V. This surface potential is set at an optimum value in accordance with the charging state of toner, the atmospheric temperature, or the humidity, in the same manner as when toner images are transferred from the photoconductor drums 10a to 10d to the first and second primary intermediate transfer drums 21a and 21b. In addition, since a difference in potential between the first and second primary intermediate transfer drums 21a and 21b and the secondary intermediate transfer drum 22 is required for transferring, it is necessary to set the surface potential of the secondary intermediate transfer drum 22 at a value in accordance with the surface potential of the first and second primary intermediate transfer drums 21a and 21b. As described above, when the charging quantity of the toner is in a range of 20-35 μC/g, under the environment of ordinary temperature and ordinary humidity, and when the surface potential of the first and second primary intermediate transfer drums 21a and 21b is about +400 V, it is desired that the surface potential of the secondary intermediate transfer drum 22 is set at about +800 V, that is, the difference in potential between the first and second primary intermediate transfer drums 21a and 21b and the secondary intermediate transfer drum 22 is set at about +400 V.

For example, the secondary intermediate transfer drum 22 used in this embodiment is formed to have an outer diameter of 42 mm as large as that of each of the first and second primary intermediate transfer drums 21a and 21b, and the resistance value is set at about 10¹¹ Ω. In addition, the secondary intermediate transfer drum 22 is a cylindrical body of revolution, which is constituted by a single layer or a plurality of layers and the surface of which has flexibility or elasticity, in the same manner as the first and second primary intermediate transfer drums 21a and 21b. Generally, a low-resistance elastic rubber layer (R=10²−10³ Ω) represented by conductive silicon rubber or the like is provided in a thickness of about 0.1-10 mm on a metal pipe serving as a metal core made of Fe, Al or the like. Further, in the outermost surface of the secondary intermediate transfer drum 22, typically, fluoro-rubber in which fluoro-resin particulates have been dispersed is formed as a high-releasable layer 3-100 μm thick, and bonded by a silane coupling agent-based bonding agent (primer).

Here, the important factors are the resistance value and the surface releasability, similarly to those in the first and second primary intermediate transfer drums 21a and 21b. However, the resistance value of the secondary intermediate transfer drum 22 has to be set to be higher than that of each of the first and second primary intermediate transfer drums 21a and 21b. If not so, the secondary intermediate transfer drum 22 would charge the first and second primary intermediate transfer drums 21a and 21b so as to make it difficult to control the surface potential of the first and second primary intermediate transfer drums 21a and 21b. There is no particular limit in material if the material satisfies such conditions. Incidentally, a secondary cleaning roll 24 is attached to the secondary intermediate transfer drum 22 so as to rotate to follow the secondary intermediate transfer drum 22. This secondary cleaning roll 24 is formed by coating a metal roll body with a piece of flocked tape of a conductive brush, and a predetermined secondary cleaning bias is applied thereto.

Next, the final toner image ranging from a unicolor image to a four-color image and formed on the secondary intermediate transfer drum 22 is tertiarily transferred to paper S passing through a paper conveying path P by the final transfer roll 30. This paper passes through the pair of resist rolls 43 through a paper feeding step, so as to be fed into a nip portion between the secondary intermediate transfer drum 22 and the final transfer roll 30. After this final transfer step, the final toner image formed on the paper is fixed by the pair of fixing rolls 44 in the fixing unit 4. Thus, a series of image forming processes are completed.

For example, the final transfer roll 30 is formed to have an outer diameter of 20 mm, and the resistance value R is set at about 10⁸ Ω. This final transfer roll 30 is formed so that a coating layer composed of urethane rubber or the like is provided on a metal shaft, and coating is given thereon in accordance with necessity. The optimum value of a voltage applied to the final transfer roll 30 varies in accordance with the atmospheric temperature, the humidity, the kind of paper (resistance value or the like), and so on. The optimum value is approximately in a range of from +1,200 V to +5,000 V. In this embodiment, a constant current system is adopted, and a current of about +10 μA is applied under the standard environment, so as to obtain a substantially appropriate transfer voltage (+1,600 to +2,000 V).

In such a series of transfer steps, a part of toner with positive polarity in a (−) charged image may become (+) charged toner with reversed polarity due to Paschen discharge or charge injection when the toner image passes through a transfer portion in any transfer step. Such (+) charged toner is not transferred to the next step but flows back to the upstream side. Thus, the (+) charged toner adheres to and is deposited on the charging units 11a to 11d that are the highest in negative potential. Discharge is activated in such portions of the charging units 11a to 11d to which the toner has adhered, so that the surface potential of the photoconductor drums 10a to 10d has a tendency to increase. Thus, in the surface potential of the photoconductor drums 10a to 10d, unevenness appears among the portion to which a large amount of toner has adhered, the portion to which a small amount of toner has adhered, and the portion to which no toner has adhered. When there appears unevenness in the surface potential of the photoconductor drum 10a, 10b, 10c or 10d, unevenness occurs in the latent image potential even if uniform exposure for forming an electrostatic latent image is applied to the image on the photoconductor drum 10a, 10b, 10c or 10d. As a result, there is produced a difference in the quantity of development. Thus, particularly when a halftone image is developed, density unevenness becomes conspicuous.

Thus, in this embodiment, in order to prevent such density unevenness caused by toner adhering to the charging units 11a to 11d, the following cleaning operation is carried out at predetermined timing such as before printing operation, after printing operation, or whenever the number of continuously printed sheets reaches a predetermined number.

Voltages with a potential gradient are applied sequentially to the respective bodies of revolution, that is, the charging units 11a to 11d, the photoconductor drums 10a to 10d, the first and second primary intermediate transfer drums 21a and 21b, the secondary intermediate transfer drum 22 and the final transfer roll 30 so that the final transfer roll 30 has the highest negative potential. Thus, (+) charged toner with reversed polarity adhering to and deposited on the charging units 11a to 11d during the printing operation is transferred and moved in turn up to the final transfer roll 30 in the cleaning operation. Then, the toner is recovered by a cleaning unit 31 including a final cleaning member 32 such as a blade provided in contact with the final transfer roll 30.

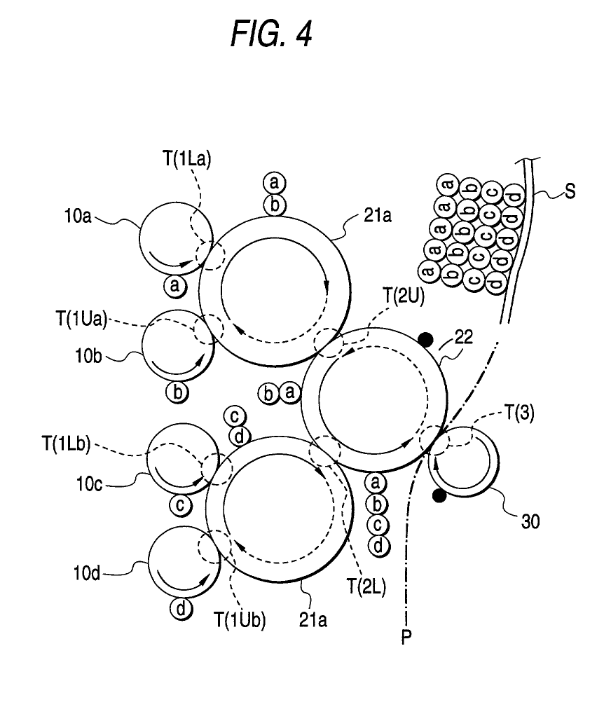

FIG. 4 explains the respective transfer steps of this full color printer 100. The photoconductor drum 10a makes contact with the first primary intermediate transfer drum 21a in a primary transfer position T(1La), while the photoconductor drum 10b makes contact with the first primary intermediate transfer drum 21a in a primary transfer position T(1Ua). In addition, this first primary intermediate transfer drum 21a makes contact with the secondary intermediate transfer drum 22 in a secondary transfer position T(2U). Here, with reference to this secondary transfer position T(2U), the primary transfer position T(1Ua) is located upstream in the rotating direction of the first primary intermediate transfer drum 21a, while the primary transfer position T(1La) is located more downstream than the primary transfer position T(1Ua).

Similarly, the photoconductor drum 10c makes contact with the second primary intermediate transfer drum 21b in a primary transfer position T(1Lb), while the photoconductor drum 10d makes contact with the second primary intermediate transfer drum 21b in a primary transfer position T(1Ub). In addition, this second primary intermediate transfer drum 21b makes contact with the secondary intermediate transfer drum 22 in a secondary transfer position T(2L). Here, with reference to this secondary transfer position T(2L), the primary transfer position T (1Ub) is located upstream in the rotating direction of the second primary intermediate transfer drum 21b, while the primary transfer position T(1Lb) is located more downstream than the primary transfer position T(1Ub).

In addition, the secondary intermediate transfer drum 22 makes contact with the final transfer roll 30 in a tertiary transfer position T(3) Then, with reference to this tertiary transfer position T(3), the secondary transfer position (2U) is located upstream in the rotating direction of the secondary intermediate transfer drum 22, while the secondary transfer position T (2L) is located more downstream than the secondary transfer position T(2U).

In addition, in FIG. 4, outline circles designate toner in toner images formed on the respective photoconductor drums 10a to 10d. That is, a toner image b on the photoconductor drum 10b is primarily transferred to the first primary intermediate transfer drum 21a in the primary transfer position T(1Ua). A toner image a on the photoconductor drum 10a is primarily transferred onto the toner image b in the primary transfer position T(1La). Accordingly, in the first primary intermediate transfer drum 21a, the toner image a as a second layer (surface layer) is superimposed on the toner image b as a first layer (bottom layer) When these superimposed toner images are secondarily transferred in the secondary transfer 10 position T(2U), the toner image b as a second layer (surface layer) is superimposed on the toner image a as a first layer (bottom layer) in the secondary intermediate transfer drum 22.

On the other hand, a toner image d on the photoconductor drum 10d is primarily transferred to the second primary intermediate transfer drum 21b in the primary transfer position T(1Ub). A toner image c on the photoconductor drum 10c is primarily transferred onto the toner image d in the primary transfer position T (1Lb). Accordingly, in the second primary intermediate transfer drum 21b, the toner image c as a second layer (surface layer) is superimposed on the toner image d as a first layer (bottom layer). When these superimposed toner images are secondarily transferred in the secondary transfer position T(2L), the toner image c and the toner image d are secondarily transferred onto the toner images which have been secondarily transferred in the secondary transfer position T(2U) in the secondary intermediate transfer drum 22. Here, the toner image a as a first layer (bottom layer), the toner image b as a second layer, the toner image c as a third layer and the toner image d as a fourth layer (surface layer) are superimposed on the secondary intermediate transfer drum 22.

Then, when these toner images are tertiarily transferred (finally transferred) onto the paper S in the tertiary transfer position T(3), the toner image d as a first layer, (bottom layer), the toner image c as a second layer, the toner image b as a third layer and the toner image a as a fourth layer (surface layer) are superimposed on the paper S.

Incidentally, each of the toner images a to d corresponds to any one of yellow Y, magenta M, cyan C and black K.

TABLE 1

| No. | a | B | c | d |
|---|---|---|---|---|
| 1 | Y | M | C | K |
| 2 | Y | M | K | C |
| 3 | Y | C | M | K |
| 4 | Y | C | K | M |
| 5 | Y | K | M | C |
| 6 | Y | K | C | M |
| 7 | M | Y | C | K |
| 8 | M | Y | K | C |
| 9 | M | C | Y | K |
| 10 | M | C | K | Y |
| 11 | M | K | Y | C |
| 12 | M | K | C | Y |
| 13 | C | Y | M | K |
| 14 | C | Y | K | M |
| 15 | C | M | Y | K |
| 16 | C | M | K | Y |
| 17 | C | K | Y | M |
| 18 | C | K | M | Y |
| 19 | K | Y | M | C |
| 20 | K | Y | C | M |
| 21 | K | M | Y | C |
| 22 | K | M | C | Y |
| 23 | K | C | Y | M |
| 24 | K | C | M | Y |

Table 1 explains all the combinations of these toner images a to d and the respective colors Y to K. For example, case No. 1 shows the case where the toner images a, b, c and d correspond to yellow Y, magenta M, cyan C and black K respectively. Combinations for solving technical problems caused by various transfer steps will be described below as Example 1 and 2.

### EXAMPLE 1

In FIG. 4, black circles designate transfer residual toner, transfer potential hysteresis, and cleaning failure toner. It is known that such transfer residual toner or the like causes an obstacle to secondary transferring. In the configuration of the full color printer 100 according to the embodiment, the position T(2U) than in the secondary transfer position T(2L). On the other hand, there is a tendency that a toner image K of black K is required to have a higher picture quality than any other color image because images are often formed in monochrome color, that is, in black and white.

It is therefore preferable that the toner image to be transferred to the first primary intermediate transfer drum 21a is not black K. In other words, it is preferable that the toner image to be transferred to the second primary intermediate transfer drum is black K. This corresponds to the combinations of the cases No. 1-4, 7-10 and 13-16 in Table 1.

### EXAMPLE 2

In FIG. 4, of the toner images transferred onto the first and second primary intermediate transfer drums 21a and 21b, the toner image a and the toner image c which are surface layers may have toner spread or blur at the time of secondary transferring. It is therefore preferable that each of the toner images a and c has a color as inconspicuous as possible, that is, as high in brightness as possible. In addition, toner having reversed polarity is produced in the respective transfer steps. Due to the configuration of the apparatus, the largest quantity of such reversed-polarity toner adheres to the charging roll 11b, and the second largest quantity of the reversed-polarity toner adheres to the charging roll 11d. Then, at the time of the cleaning mode described previously, the reversed-polarity toner adhering to the charging rolls 11b and 11d is released to the photoconductor drums 10b and 10d. However, the reversed-polarity toner adhering to the charging rolls 11b and 11d may be mixed into the developing units 13b and 13d respectively. In this case, when the brightness of the original toner in each of these developing units 13b and 13d is low, there is no great influence on the picture quality even if some quantity of the reversed-polarity toner is mixed in the original toner. It is therefore preferable that each of the toner images b and d has a color low in brightness.

On the other hand, the toner image Y of yellow Y is generally higher in brightness than any other toner image of magenta M, cyan C and black K. Incidentally, the relationship of the magnitude of brightness among yellow Y, cyan C, magenta M and black K is expressed by K<M≈C<Y.

It is therefore preferable that the toner image a or the toner image c is yellow. This corresponds to the combinations of the cases No. 1-6, 9, 11, 15, 17, 21 and 23 in Table 1. In addition, it is preferable that at least the toner image a or the toner image c is not black K.

TABLE 2

| No. | a | B | c | d | Example 1 | Example 2 |
|---|---|---|---|---|---|---|
| 1 | Y | M | C | K | ◯ | ◯ |
| 2 | Y | M | K | C | ◯ | ◯ |
| 3 | Y | C | M | K | ◯ | ◯ |
| 4 | Y | C | K | M | ◯ | ◯ |
| 5 | Y | K | M | C | | ◯ |
| 6 | Y | K | C | M | | ◯ |
| 7 | M | Y | C | K | ◯ | |
| 8 | M | Y | K | C | ◯ | |
| 9 | M | C | Y | K | ◯ | ◯ |
| 10 | M | C | K | Y | ◯ | |
| 11 | M | K | Y | C | | ◯ |
| 12 | M | K | C | Y | | |
| 13 | C | Y | M | K | ◯ | |
| 14 | C | Y | K | M | ◯ | |
| 15 | C | M | Y | K | ◯ | ◯ |
| 16 | C | M | K | Y | ◯ | |
| 17 | C | K | Y | M | | ◯ |
| 18 | C | K | M | Y | | |
| 19 | K | Y | M | C | | |
| 20 | K | Y | C | M | | |
| 21 | K | M | Y | C | | ◯ |
| 22 | K | M | C | Y | | |
| 23 | K | C | Y | M | | ◯ |
| 24 | K | C | M | Y | | |

In Table 2, preferred cases in Example 1 and Example 2 are summarized. As the configuration of the full color printer 100, it is preferable to adopt a case marked with at least one symbol “0”. It is more preferable to adopt a case marked with to symbols “0”.

As described above in detail, according to the invention, it is possible to provide an image forming apparatus in which image defects caused by electrostatic transfer are reduced.

What is claimed is:

1. An image forming apparatus comprising:
a plurality of image carriers for carrying toner images;
a plurality of primary transferrers each abutting against at least one of the image carrier so that the toner images on the image carrier are primary transferred thereto;
a secondary transferrer abutting against at least two of the primary transferrers so that the toner images on the primary transferrers are secondary transferred thereto; and
a tertiary transferrer abutting against the secondary transferrer to tertiarily transfer a toner image on the secondary transferrer to a predetermined medium;
wherein
a black toner image is transferred to one of the primary transferrer other than the primary transferrer located most upstream in a rotating direction of the secondary transferrer with reference to a first position where the tertiary transferrer abuts against the secondary transferrer.

2. An image forming apparatus comprising:
a plurality of image carriers for carrying toner images of different colors respectively;
a plurality of primary transferrers each abutting against at least one of the image carrier so that the toner images on the image carrier are primary transferred thereto;
a secondary transferrer abutting against at least two of the primary transferrers so that the toner images on the primary transferrers are secondary transferred thereto; and
a tertiary transferrer abutting against the secondary transferrer to tertiarily transfer a toner image on the secondary transferrer to a predetermined medium;
wherein
a black toner image is transferred to one of the primary transferrer located most downstream in a rotating direction of the secondary transferrer with reference to a first position where the tertiary transferrer abuts against the secondary transferrer.

3. The image forming apparatus according to claim 2,
wherein
a plurality of the image carriers abut against one of the primary transferrers; and
a toner image formed on the image carrier located upstream in a rotating direction of the primary transferrer is higher in brightness than a toner image formed on the image carrier located downstream with reference to a second position where the secondary transferrer abuts against the primary transferrer.

4. An image forming apparatus comprising:
a plurality of image carriers for carrying toner images;
a plurality of primary transferrers abutting against at least one of a plurality of the image carriers so that the toner images on the image carriers are primarily transferred thereto;
a secondary transferrer abutting against at least two of the primary transferrers so that toner images on the primary transferrers are secondarily transferred thereto; and
a tertiary transferrer abutting against the secondary transferrer to tertiarily transfer a toner image on the secondary transferrer to a predetermined medium;
wherein
a plurality of the image carriers abut against one of the primary transferrers; and
a toner image formed on the image carrier located upstream in a rotating direction of the primary transferrer is higher in brightness than a toner image formed on the image carrier located downstream with reference to a second position where the secondary transferrer abuts against the primary transferrer.

5. The image forming apparatus according to claim 4,
wherein a toner image of the image carrier located most down stream in the rotating direction with reference to the second position is yellow.

6. An image forming apparatus comprising:
four image carriers for carrying color toner images of yellow, magenta, cyan and black respectively;
a first primary intermediate transferrer abutting against two of the image carriers so that toner images on the two image carriers are primarily transferred thereto;
a second primary intermediate transferrer abutting against the other two of the four image carriers so that toner images on the other two image carriers are primarily transferred thereto;
a secondary intermediate transferrer abutting against the first and second primary intermediate transferrers so that toner images on the first and second primary intermediate transferrers are secondarily transferred thereto; and
a final transferrer abutting against the second intermediate transferrer to finally transfer a toner image on the secondary intermediate to a recording medium;
wherein
the first primary intermediate transferrer is located upstream in a rotating direction of the secondary intermediate transferrer with reference to a first position where the final transferrer abuts against the secondary intermediate transferrer;
the second primary intermediate transferrer is located down stream in a rotating direction of the secondary intermediate transferrer with reference to the first position; and
a black toner image is not transferred to the first primary intermediate transferrer.

7. An image forming apparatus comprising:
four image carriers for carrying color toner images of yellow, magenta, cyan and black respectively;
a first primary intermediate transferrer abutting against two of the image carriers so that toner images on the two image carriers are primarily transferred thereto;
a second primary intermediate transferrer abutting against the other two of the four image carriers so that toner images on the other two image carriers are primarily transferred thereto;
a secondary intermediate transferrer abutting against the first and second primary intermediate transferrers so that toner images on the first and second primary intermediate transferrers are secondarily transferred thereto; and
a final transferrer abutting against the second intermediate transferrer to finally transfer a toner image on the secondary intermediate transferrer to a recording medium;
wherein
the first primary intermediate transferrer is located upstream in a rotating direction of the secondary intermediate transferrer with reference to a first position where the final transferrer abuts against the secondary intermediate transferrer;
the second primary intermediate transferrer is located downstream in a rotating direction of the secondary intermediate transferrer with reference to the first position; and
a black toner image is transferred to the second primary intermediate transferrer.

8. The image forming apparatus according to claim 7,
wherein
a toner image formed on the image carrier located upstream in a rotating direction of the primary intermediate transferrer is higher in brightness than a toner image formed on the image carrier located downstream with reference to a second position where the secondary intermediate transferrer abuts against the primary intermediate transferrer.

9. An image forming apparatus comprising:
four image carriers for carrying color toner images of yellow, magenta, cyan and black respectively;
a first primary intermediate transferrer abutting against two of the image carriers so that toner images on the two image carriers are primarily transferred thereto;
a second primary intermediate transferrer abutting against the other two of the four image carriers so that toner images on the other two image carriers are primarily transferred thereto;
a secondary intermediate transferrer abutting against the first and second primary intermediate transferrers so that toner images on the first and second primary intermediate transferrers are secondarily transferred thereto; and
a final transferrer abutting against the second intermediate transferrer to finally transfer a toner image on the secondary intermediate to a recording medium;
wherein
with reference to a second position where the secondary intermediate transferrer abuts against the primary intermediate transferrer, a toner image formed on an image carrier located upstream in a rotating direction of the primary intermediate transferrer is higher in brightness than a toner image formed on an image carrier located downstream.

10. The image forming apparatus according to claim 9,
wherein
a toner image of the image carrier located most downstream in the rotating direction with reference to the second position is yellow.

11. An image forming apparatus comprising:
a plurality of image carriers for carrying toner images;
a plurality of primary transferrers each abutting against at least one of the image carrier so that the toner images on the image carrier are primary transferred thereto;
a secondary transferrer abutting against at least two of the primary transferrers so that the toner images on the primary transferrers are secondary transferred thereto; and
a tertiary transferrer abutting against the secondary transferrer to tertiarily transfer a toner image on the secondary transferrer to a predetermined medium;
wherein
a black toner image is carried by one of the image carriers abutting against the primary transferrers excluding one located most upstream in a rotating direction of the secondary transferrer with reference to a first position where the tertiary transferrer abuts against the secondary transferrer.
